(19) United States
(12) Patent Application Publication
(10) Pub. No.: US 2019/0142550 A1
(43) Pub. Date: May 16, 2019

(54) ANATOMICAL SELF-GRIPPING DENTAL BARRIER DEVICE

(71) Applicant: MAVRIK DENTAL SYSTEMS LTD, Ra'anana (IL)

(72) Inventor: Daniel SANDERS, West Orange, NJ (US)

(21) Appl. No.: 16/247,787

(22) Filed: Jan. 15, 2019

Related U.S. Application Data
(63) Continuation-in-part of application No. 15/366,165, filed on Dec. 1, 2016.

(51) Int. Cl. A61C 5/90; A61C 5/80

(52) U.S. Cl. CPC A61C 5/90; A61C 19/066; A61C 5/80

(57) ABSTRACT

An anatomical pre-shaped oral anatomy dental barrier, for covering a treatment area of the oral cavity, comprising an elastomeric material capable of intimately conforming to the contours of the anatomical part of the oral cavity so as to provide a substantially fluid sealed barrier to the oral anatomical part it covers, and including a self-gripping structure. The dental barrier can be a stand-alone device or for use in conjunction with other intra-oral devices where in either case the selective exposure of the erupted teeth is accomplished whilst the surrounding oral tissues are covered by the device.

### CROSS REFERENCE TO RELATED APPLICATIONS

This application is a continuation-in-part of U.S. patent application Ser. No. 15/366,165 filed Dec. 1, 2016, entitled “DENTAL GUM GUARDS AND DEVICES, METHODS, AND SYSTEMS THEREOF”, which is incorporated in its entirety herein by reference.

### FIELD OF THE INVENTION

The present invention relates to methods and devices useful in providing self-gripping covers for anatomical parts, such as during treatment of the parts, particularly to oral barriers for dental treatments.

### BACKGROUND OF THE INVENTION

In dental medicine, many treatment materials are typically placed within the oral cavity on the hard (teeth) tissues and soft (inner mucosal epithelium of the cheek, lips, and gingiva and the tongue) tissues.

These treatment materials are placed topically on these tissues or may be inserted (injected) in the space between them, for example, in the naturally occurring sulcus at the tooth/gum line.

These treatment materials are typically applied to the tissues in an “open” manner, namely, without any covering material or containment device. This significantly reduces their desired therapeutic effect as the materials are immediately exposed to saliva contamination (containing numerous pathogenic microorganisms) and salivary washout (or fluid/solids ingestion washout) in a very short time. This time range can be as short as a few seconds to around 10 minutes or more, depending on salivary flow, the viscosity of the treatment material or whether the patient ingests solids or liquids after application of the treatment material.

Additionally, currently known devices use a cover device that covers both the teeth and the gums. These are typically custom made to a specific patient using the following fabrication method. Dental molds are taken of the patient's teeth and surrounding gums and dental stone cast models are poured and allowed to harden. These cast models are removed from the molds and a vacuum-formed thin plastic custom made tray for that specific patient is formed and trimmed to cover over both the teeth and a narrow portion of the surrounding gums. These typically leak the treatment material out of them and also allow saliva to seep inside of them as the stiff material of the tray is difficult to adapt closely to the undulating and varied topography of the teeth and surrounding gums of each individual patient which they are meant to cover.

Additionally, patches onto whose inner surface a thin layer of treatment layer has been adhered are used to cover small areas of the gum tissue. Due to their size they can only treat very limited areas of the soft tissues of the oral cavity and cannot be used to treat the teeth as they cannot be adhered to the teeth structure. They are also easily dislodged by the tongue or contact with the inner cheek and lip muscles.

Additionally, light curable foam materials are manually applied to the gingiva to create a protective barrier against high concentration applications of peroxide for professional teeth whitening treatments. The application of these materials are manually intensive and require a high skill level to apply. Additionally, they are often highly brittle and tend to break or fall off the gingiva and are easily dislodged when even slight pressure or flexing force is applied to them. They are therefore unsuitable to use a gingival barrier in conjunction with an intra-oral mouthpiece.

Additionally, rubber dam barriers consisting typically of some form of latex or rubber sheet or barrier are applied to provide for a “dry field” for the erupted portions of the teeth to prevent moisture contamination of the erupted portions of the teeth from the oral cavity during many dental procedures. The rubber dams are typically made of flat sheets of latex rubbers and require manually punched holes by the dentist to allow for them to be placed through the anatomical crown portions of the teeth so as to allow them to passively drape over the surrounding oral structures (including the gum ridges) of the oral cavity. These rubber dam barriers are fixed or retained in the mouth by using some type of clamping apparatus to secure or anchor the dam barrier in the mouth and are not self-gripping to the oral structures that they passively cover. As these devices are typically very cumbersome and very large, require an additional external frame to keep their loose ends away from the treatment area, are uncomfortable for the patient due to the clamping apparatus, their size and coverage of large areas of the intra-oral anatomical structures; all the above preclude their use in conjunction with the insertion of an intra-oral mouthpiece into the mouth.

It is an object of the present invention to provide an improved device that aims to overcome or at least alleviate the above-mentioned drawbacks.

### SUMMARY OF THE INVENTION

In accordance with a first aspect of the present invention, there is provided an anatomical self-gripping intra-oral barrier for covering a treatment area of an anatomical oral part, the barrier comprising an elastomeric material capable of conforming to the contours of the anatomical oral part.

In some embodiments an anatomical self-gripping barrier is provided for covering a treatment area of an anatomical part, the self-gripping barrier comprising: a preformed elastomeric material that is pre-shaped to the three dimensional shape of either the maxillary or mandibular alveolar ridges and is capable of conforming to the contours of said anatomical parts; multiple pre-formed teeth hole cut-outs incorporated into the barrier for the insertion there through of a variable number of the erupted anatomical crown portions of the teeth. Once inserted through the teeth holes and fully seated onto either the upper or lower ridges or any portion of said ridges, the barrier which is pre-shaped to intimately grip in a press-type fit (pre-loaded to fit tightly) to the covered ridge anatomy does not require any external fixation or clamping devices to fix it to the gum ridge that it covers. The intimate fit to the gum ridge is sufficient to also provide a substantially fluid sealed barrier to the covered ridge, preventing ingress of saliva or other fluids and preventing egress of any materials placed under the barrier either before or after its insertion and seating onto the ridge.

In some embodiments an anatomical self-gripping elastomeric oral barrier is provided, wherein the elastomeric material of the barrier is substantially liquid impermeable and gas permeable.

In some embodiments an anatomical self-gripping barrier is provided, wherein the barrier comes in several stock sizes for covering either the maxillary or mandibular gum ridges.

In some embodiments an anatomical self-gripping barrier is provided, wherein one or more treatment material layers are included on at least one surface of the barrier.

In some embodiments a kit of parts for covering a treatment area is provided, the kit comprising one or more barriers of different sizes or lengths, for the upper and or lower jaws and wherein these barriers may contain a variable number, size and or shapes of pre-cut out teeth holes or perforated holes.

In some embodiments the kit further comprises one or more therapeutic medications or agents for application onto the oral anatomy that is then covered by any of the variety of kit barriers.

In some embodiments the barrier is applied to a gum ridge or ridges and then a mouthpiece that substantially covers the teeth and gum ridge or ridges is inserted into the oral cavity and onto the barrier or barriers, to provide for a continuous fluid seal of the mouthpiece treatment cavities to the barrier(s).

In further embodiments, a method is provided for applying an oral self-gripping ridge barrier to cover a treatment area of an oral cavity, the method comprising: a barrier that is of smaller dimension than the barrier it cover and so provides a press fitting barrier so that it substantially conforms to the contours of the oral anatomical part to be treated, wherein the press fit provides a substantially fluid sealed covering of the oral anatomical part, and wherein the fully seated barrier remains elastomeric and is substantially gas permeable but liquid impermeable.

### DESCRIPTION OF THE DRAWINGS

The principles and operation of the system, apparatus, and method according to the present invention may be better understood with reference to the drawings, and the following description, it being understood that these drawings are given for illustrative purposes only and are not meant to be limiting, wherein:

FIG. 1a is a top view of the upper self-gripping (maxillary) ridge barrier 1, illustrating the outer aspect of the barrier 1; with anatomically shaped anterior teeth holes 1a and anatomically shaped posterior teeth holes 1b, according to some embodiments;

FIG. 1b is a top and rear view according to some embodiments of the ridge barrier of FIG. 1a wherein are depicted the palatal aspects 1g of the barrier 1, the buccal aspects 1h, and the occlusal aspects 1i.

FIG. 1c is a bottom view according to some embodiments of the ridge barrier of FIG. 1a, illustrating the inner aspect 1j of the ridge barrier 1; wherein are depicted the inner aspects of the anterior teeth holes 1a and posterior teeth holes 1b.

FIG. 1d is a bottom and rear view according to some embodiments of the ridge barrier of FIG. 1a wherein are depicted the buccal roll border 1d and the palatal roll border 1k.

FIG. 1e is a top and front view according to some embodiments of the ridge barrier of FIG. 1a wherein are depicted the frenum notch 1f and the thinned-out circumferential borders 1c of the teeth holes 1a and 1b

FIG. 1f. are top and side views according to some other embodiments of the ridge barrier of FIG. 1a wherein are depicted the buccal aspect 1h, the buccal and palatal projections/bumps 1e for proper alignment of the ridge barrier 1 to the dentition, and the palatal aspect 1g of the ridge barrier 1.

FIG. 2a is a top and front view according to some other embodiments of the self-gripping lower (mandibular) ridge barrier 2; wherein are depicted the anatomically shaped anterior teeth holes 2a, the anatomically shaped posterior teeth holes 2b and the buccal roll border 2d.

FIG. 2b is a top and rear view according to some other embodiments of the lower ridge self-gripping barrier 2; wherein are depicted the lingual projection/bump 2e, the lingual aspect 2g, and the occlusal aspect 2i of the lower ridge barrier 2.

FIG. 2c is a bottom view according to some other embodiments of the lower ridge self-gripping barrier 2; wherein are depicted the inner aspect 2j, the anterior 2a and posterior 2b teeth holes, the buccal roll border 2d, and the lingual roll border 2k.

FIG. 2d is a bottom and rear view according to some other embodiments of the lower ridge self-gripping barrier 2; wherein are depicted the frenum notch 2f, the lingual side projection/bump 2e and the lingual roll border 2k.

FIG. 2e is a top and front view according to some other embodiments of the lower ridge self-gripping barrier 2; wherein are depicted the thinned out circumferential borders 2c of the anatomically shaped anterior teeth holes 2a, and posterior teeth holes 2b.

FIG. 2f is a top and side view according to some other embodiments of the lower ridge self-gripping barrier 2; wherein are depicted the lingual aspects 2g, the buccal aspects 2h and the thinned out circumferential borders 2c of the anatomically shaped anterior teeth holes 2a, and posterior teeth holes 2b.

FIG. 3a is a front view of a model of the maxillary jaw wherein are depicted the maxillary ridge 1o covered by the upper self-gripping ridge barrier 1 when said barrier is inserted over and through the erupted portions of the maxillary anterior teeth 1l and maxillary posterior teeth 1m and seated down so that the thinned out circumferential borders 1c of the anatomically shaped anterior teeth holes 1a, and posterior teeth holes 1b are seated at the level of the gumlines respectively of the anterior maxillary teeth 1l and posterior maxillary teeth 1m. Also illustrated is the spatial relation of the buccal roll border 1d to the maxillary muco-buccal fold 1n and the frenum notch's 1f position in relation to the maxillary ridge 1o.

FIG. 3b is a front view of a model of the mandibular jaw wherein are depicted the mandibular ridge 2o covered by the lower self-gripping ridge barrier 2 when said barrier is inserted over and through the erupted portions of the mandibular anterior teeth 2l and mandibular posterior teeth 2m and seated down so that the thinned out circumferential borders 2c of the anatomically shaped anterior teeth holes 2a, and posterior teeth holes 2b are seated at the level of the gumlines respectively of the anterior mandibular teeth 1l and posterior mandibular teeth 1m. Also illustrated is the spatial relation of the buccal roll border 2d to the mandibular muco-buccal fold 2n and the frenum notch's 2f position in relation to the mandibular ridge 2o.

### DETAILED DESCRIPTION OF THE INVENTION

The following description is presented to enable one of ordinary skill in the art to make and use the invention as provided in the context of a particular application and its requirements. Various modifications to the described embodiments will be apparent to those with skill in the art, and the general principles defined herein may be applied to other embodiments. Therefore, the present invention is not intended to be limited to the particular embodiments shown and described but is to be accorded the widest scope consistent with the principles and novel features herein disclosed. In other instances, well-known methods, procedures, and components have not been described in detail so as not to obscure the present invention.

The word “barrier” as used herein may encompass various protective materials with or without adhesives that may be utilized to cover, dress or place over a target area or object(s) while undergoing a treatment, to cover or protect a target area, and optionally prevent the flow of liquids or materials from or to the target area.

The word “self-gripping” as used herein may encompass various protective materials with or without adhesives that may be placed to cover, dress or place over a target area or object(s) while undergoing a treatment, to cover or protect a target area, and optionally prevent the flow of liquids or materials from or to the target area without the need for any additional clamping or fixation devices.

The word “elastomeric” as used herein may encompass various protective materials that maintain their flexibility, stretch and fit to the covered anatomical body part both before and after seating and fitting onto the anatomical part.

The word “anatomical” as used herein may encompass various three-dimensional natural morphologies of a given oral structure such as the maxillary and mandibular alveolar jaw ridges or erupted portions of the teeth or any other oral on non-oral anatomical body part.

In accordance with a first aspect of the present invention, there is provided an anatomical self-gripping elastomeric barrier for covering a treatment area of an anatomical oral part, the barrier comprising an elastomeric material capable of conforming and intimately fitting to the contours of the anatomical part without the need for any external or additional fixation or clamping devices or elements.

More preferably, the barrier conforms to a gum ridge anatomy with the barrier forming an enclosed protective cover over the gum ridge or part of the gum ridge. The barrier may comprise a partial or full U-shaped arch which fits intimately and preferably with a pre-loaded shape (press fit) to the oral anatomy to provide a high level of conformity. The barrier, in some embodiments, may be provided with pre-perforated teeth holes for easy removal and passage of the anatomical crown portions of the erupted teeth there through or pre-configured cut-out teeth holes may be provided of varying shapes and dimensions for receipt of the anatomical crown portions of the erupted teeth there through whereby the anatomical crown portions of the teeth remain substantially uncovered and exposed to the oral cavity whilst the surrounding gum tissue and gum ridge are substantially covered by the barrier. Some portions of the gum ridge may be edentulous and the gum barrier in these segments may not have cut out teeth holes to substantially cover these segments of the gum ridge. This embodiment of the oral barrier may be advantageous to apply over newly placed dental implant sites or tooth extraction sites.

The preformed shape of the self-gripping barrier is formed to generally conform to the three-dimensional shape of a portion of the oral cavity to facilitate easy and rapid insertion and removal of the barrier from the target area.

The preformed elastomeric barrier may be three-dimensionally shaped to be of smaller dimensions than the gum ridge so that when placing and fully seated onto the ridge the “pre-loaded” shape of the barrier presses firmly onto the ridge to provide a self-gripping flexible and fluid sealed barrier to the covered ridge.

The pre-loading may be a shape that is 5%, 10% or even 20% or more smaller in all its dimensions to the dimensions of the covered anatomical oral anatomy.

The preformed barrier may in some embodiments cover only the gum ridge or a portion of the gum ridge whilst in the main or entirely not covering the hard or soft palate, mucco-buccal folds, tongue, inner surfaces of the cheek or lips, and the floor of the mouth or airway.

The preformed barrier may include teeth holes whose contour and profile closely matches the natural gum line of the erupted portions of the teeth to further enhance the fit and seal of the barrier to the gum ridge as well as to provide maximal exposure of the erupted teeth not covered by the barrier.

The preformed barrier may incorporate a thickened edge or peripheral roll border on either the buccal and or lingual/palatal aspects of the barrier. Said thickened roll border facilitates the insertion and full and proper seating of the barrier onto the ridge anatomy.

More specifically, the roll border or borders facilitate the operator's grip of the barrier and more specifically facilitates the operator's ability to stretch the interdental tension bridges and thin out their cross-sectional thickness to help snap them past the frictional fit of the natural teeth contacts between the teeth without tearing the bridges.

Preferably, the elastomeric material of the barrier is substantially liquid impermeable and gas permeable. In some embodiments, the elastomeric material has high tear strength properties. This allows for the insertion of the relatively thin cross-sectional areas between the teeth holes here forth to be described as the inter-dental tension bridges to be stretched by the operator and frictionally forced through the natural teeth contacts between the teeth without tearing when fully seating the barrier past the erupted teeth contacts and onto the gum ridge.

More preferably, the self-gripping barrier is comprised of an elastomeric material with a relatively low modulus of Young, relatively high elongation to break, relatively high tear strength and relatively low recoil properties.

As described above, preferably the mechanical properties of the barrier resist tearing when placing the tooth holes over and through the anatomical crowns of the teeth and allowing for the interdental bridges of the drape between the teeth to be snapped through the interproximal (interdental) teeth contact areas between the teeth without tearing the bridges while allowing the bridges to seat firmly down between the teeth (interproximally/interdentally) at the level of the gum line.

Preferably the mechanical properties of the barrier interdental bridges allow them to be stretched to substantially thin them and allow for easier insertion of the interdental bridges through the contact areas between the teeth without tearing them.

The seating of the intact interdental bridge portions below the contact areas is vital for achieving a snug circumferential fit of the drape around the cervical necks of the anatomical crown portions of the erupted teeth and for providing a good seal of the barrier to the surrounding gum tissue at the level of the gum line with the present invention.

When inserted and fully seated to intimately conform the barrier to the gum ridge anatomy of the patient, the barrier provides for a superior seal of the barrier on the gum ridge from any external caustic agents such as high concentration peroxide whitening agents or alternatively, to effectively contain and prevent the leakage or saliva washout of medicaments or therapeutic agents applied underneath the drape prior to placement of the barrier or post placement of the barrier.

The snugly fitted barrier can now also be utilized as an effective wound dressing or containment barrier for medicaments or therapeutic agents applied to, for example, the periodontal pockets of the gums surrounding the teeth and or the gum ridges prior to insertion and adaptive conformation of the barrier as previously described.

This allows for these medicaments or therapeutic agents to be maintained in high concentrations on or inside the elastomeric barrier covering the target soft tissues by effectively preventing them from leaking out and preventing the saliva from diluting and washing them out as well. Maintaining these medicaments or therapeutic agents in place at high concentrations on or in the target tissues significantly extends their exposure time and therefore their therapeutic window of action. This ability of the barrier of the present invention may allow for achieving significantly enhanced therapeutic outcomes with these medicaments or therapeutic agents particularly for patients with impaired healing such as diabetics who suffer from chronic periodontitis.

Medicaments or therapeutic agents may also be pre-applied or pre-impregnated into the inner or outer surfaces of the barrier at the time of manufacture for time released application to the gingival tissues of the gum ridges or for timed delivery into the periodontal sulcus of the teeth.

These medicaments or therapeutic agents may be pre-applied in selective patterns of application on the inner or outer surfaces of the barrier or applied in a full coating on the either the inner or outer surfaces of the barrier.

In some embodiments, as described above, an anatomical self-gripping barrier is provided, wherein the barrier is pre-formed to press fit onto the substantially the entire gum ridge anatomy, wherein the drape forms a closely fitted enclosed protective fluid sealed cover over the gum ridge with optional teeth holes for passage of erupted teeth there through.

In some embodiments an anatomical self-gripping barrier is provided, wherein the self-gripping barrier conforms to a portion of the gum ridge anatomy to provide a closely fitted enclosed protective fluid sealed cover over a portion of the gum ridge with optional holes for passage of erupted teeth there through.

In some embodiments an anatomical self-gripping barrier is provided, wherein the barrier conforms to the gum ridge anatomy, wherein the barrier forms an enclosed protective fluid sealed cover over the gum ridge with optional holes for passage of erupted teeth there through and substantially full coverage over one or several variable portions of the gum ridge that are edentulous.

The teeth hole cut outs may be 5% or 10% or 20% or more smaller in some or all of their dimensions compared to the natural cross-sectional dimensions of the teeth at the gum lines of said teeth.

These smaller dimension holes will provide a very intimate press fit of the circumferential teeth hole borders around the “necks” of the teeth, further enhancing the fluid seal of the barrier to the ridge when fully seated past the erupted portion of the teeth and covering the ridge anatomy of either the upper or lower jaws.

In some embodiments an anatomical self-gripping barrier is provided, wherein the barrier incorporates at the midline anterior section button projections or projecting bumps (between the two central incisors) as a visual and tactile aid for aligning and proper placement of the barrier onto the dentulous or partially dentulous gum ridge. This is accomplished by aligning the buttons to the midline of the anterior teeth if present (the midline being between the two central incisors) and the two teeth cut outs for the central incisors. These projections/bumps could also be located at other easily identifiable locations should these teeth be absent or in addition to the midline projections/bumps even if present.

In some embodiments an anatomical self-gripping barrier is provided, wherein a time-released medication or agent is impregnated in a full coverage layer or selectively applied layer or layers onto or into the internal surfaces of the barrier material for the timed release of said medication or agent onto or into the tissue covered by the barrier wherein the barrier provides a substantially fluid sealed barrier to prevent the egress of the medication or agent layer from within the barrier for a substantial period of time and also substantially prevents the ingress of saliva or other fluids under the barrier. This fluid seal may last for several hours, several days or several weeks.

In some embodiments an anatomical self-gripping barrier is provided, wherein the barrier incorporates cross-sectionally thinned out areas around the teeth hole cut outs compared to the cross-sectional thickness of the rest of the device. These thinned out areas may be circumferential around the various teeth hole cut-outs.

These thinned out areas enhance insertion and seating of the device onto the gum ridge as well as improving the conformity of the intimate fit of the peripheral margins of the holes to the varying morphology of the anatomical portions of the erupted teeth they seal to when the barrier is seated down on the ridge by pulling the barrier over and through the crown portions of the teeth via the teeth hole cut outs.

These thinned out areas may preferably be located on the outer aspects or the inner aspects of the ridge barrier. Where they are located on the outer aspects, these thinned out areas may appear as inward sloping beveled surfaces. These inward sloping beveled shapes of the circumferential teeth hole borders facilitates the application of sufficient quantities other materials around and onto the border of the teeth holes. These materials can be syringeable light cured or self-curing dental resin polymers. These materials can be expressed in a controlled manner from the syringe container using very fine gauge applicator tips onto the inward sloping beveled surfaces of the teeth hole borders to “caulk” or further seal the ridge barrier to the dentulous gum ridge. This enhanced seal can be utilized to protect the gum tissues of the gum ridge surrounding the teeth when high concentration hydrogen peroxide whitening treatment gels are applied. This enhanced fluid seal can be also be utilized to maximize the length of time an application of therapeutic materials/agents will remain under the ridge barrier without substantial saliva washout.

The teeth hole cut outs may be shaped to closely follow the natural anatomical cross-sectional shape of the respective upper and lower anterior and posterior teeth at the level of the gum lines of said teeth. The various anatomically correct contours of the teeth holes, especially for the anterior teeth may be elliptical on their buccal (lip side) or lingual (tongue side) aspects to allow substantially for the exposure of the cervical thirds of the teeth (third of the anatomical crown portions of the teeth near the gum lines) once the elastomeric barrier has been fully seated on the ridge it covers.

Suitable barrier elastomeric materials include but are not limited to TPE's (thermoplastic elastomers; TPU's (thermoplastic urethanes); elastomeric silicones (RTV, HTV, LSR, HCR), the material preferably being both substantially liquid impermeable and gas permeable (i.e., breathable). Preferably, the material contains millions of micro-pores per square cm.

The barrier may include one or more treatment material layers on at least one surface of the drape, for example for neutralizing treatment materials. The materials are preferably provided on the inner surfaces of the barrier but may also be provided on the outer surfaces of the barrier.

A second aspect of the present invention provides a kit of parts for installing an anatomical self-gripping barrier, the kit comprising a barrier according to the first aspect of the present invention and a treatment material or light curable resin material to further enhance the fluid seal of the barrier, optionally with at least one further barrier and/or a therapeutic or other treatment source and/or light curable resin material.

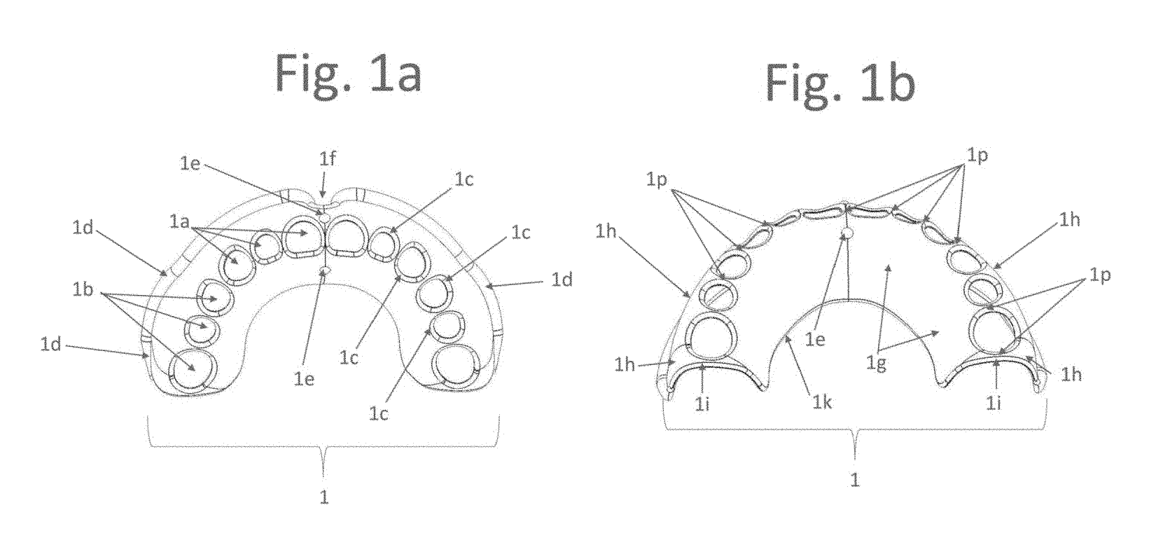

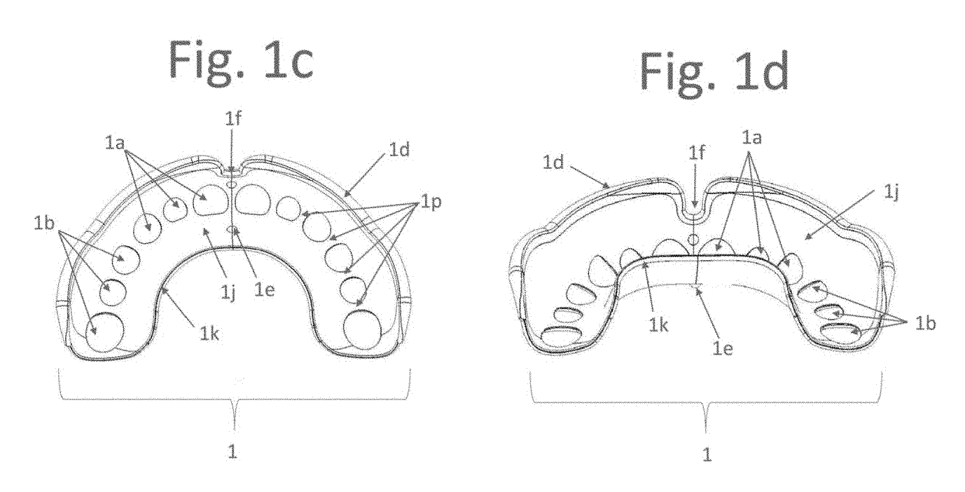

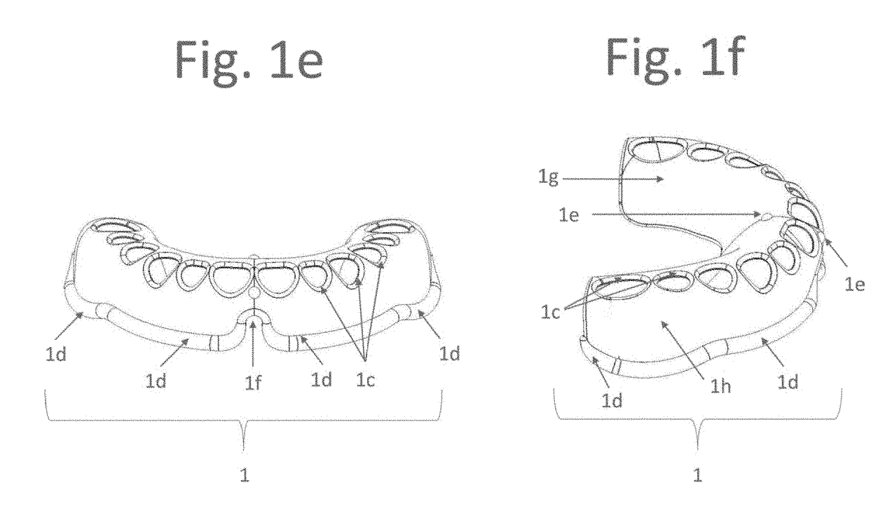

FIG. 1a is a top view of the upper self-gripping (maxillary) ridge barrier 1, illustrating the outer aspect of the barrier 1; with anatomically shaped anterior teeth holes 1a and anatomically shaped posterior teeth holes 1b, according to some embodiments; wherein are further depicted the frenum notch 1f, the thinned out circumferential borders 1c of the anterior teeth holes 1a and posterior teeth holes 1b, the buccal roll border 1d for facilitating gripping and insertion of the upper ridge barrier 1, and the buccal and lingual positioning projections/bumps 1e for easy alignment of the upper ridge barrier 1 to the maxillary teeth (not depicted).

FIG. 1b is a top and rear view according to some embodiments of the ridge barrier of FIG. 1a wherein are depicted the palatal ridge aspects 1g of the barrier 1, the buccal ridge aspects 1h, and the occlusal ridge aspects 1i. Also illustrated is the palatal projection/bump for aiding in alignment and insertion of the barrier properly onto the dentulous upper ridge, and the interdental tension bridges 1p which are stretched upon insertion of the erupted portions of the teeth through the teeth holes 1a and 1b. Stretching the interdental tension bridges facilitates snapping the bridges through the natural teeth contacts between the teeth and allows for the ridge barrier to be fully seated onto the ridge and to sit with the borders 1c of the teeth holes seated at the level of the gum lines (not depicted) of the anterior 1a and posterior teeth 1b.

FIG. 1c is a bottom view according to some embodiments of the ridge barrier of FIG. 1a, illustrating the inner aspect 1j of the ridge barrier 1 which contacts the ridge itself; wherein are depicted the inner aspects of the anterior teeth holes 1a and posterior teeth holes 1b. Also illustrated are the inner smooth surfaces of projection/bumps 1e, the inner aspects of the interdental tension bridges 1p and the buccal roll border 1d and palatal roll border 1k which aids manual gripping and inserting of the ridge barrier and fully seating it down onto the gum ridge. Grasping both roll borders, facilitates the stretching of the ridge barrier and most importantly, facilitates the stretching of the individual interdental tension bridges to thin them out cross-sectionally between the teeth and aid in inserting the bridges past the contact points so that the bridges are now seated onto the natural gum col between the teeth. This full seating of the bridges onto the ridge sections between the teeth provides a full circumferential fit of the ridge barrier to the dentulous ridge and provides for a substantially fluid sealed barrier cover for the ridge.

FIG. 1d is a bottom and rear view according to some embodiments of the ridge barrier of FIG. 1a wherein are depicted the buccal roll border 1d and the palatal roll border 1k, the inner anatomically shaped aspects of the anterior teeth holes 1 and posterior teeth holes 1b, the frenum notch 1f, and the palatal positioning/aligning projection/bump 1e.

FIG. 1e is a top and front view according to some embodiments of the ridge barrier of FIG. 1a wherein are depicted the frenum notch 1f and the thinned-out circumferential borders 1c of the teeth holes 1a and 1b. also depicted is the buccal roll border 1d for grasping and stretching the ridge barrier 1.

FIG. 1f. are top and side views according to some other embodiments of the ridge barrier of FIG. 1a wherein are depicted the buccal ridge aspect 1h of the ridge barrier 1 which cover the buccal anatomy of the natural gum ridge (not depicted), the palatal ridge aspect 1g of the ridge barrier 1 which covers the palatal anatomy of the gum ridge (not depicted). Also depicted are the buccal and palatal projections/bumps 1e for proper alignment of the ridge barrier 1 to the dentition.

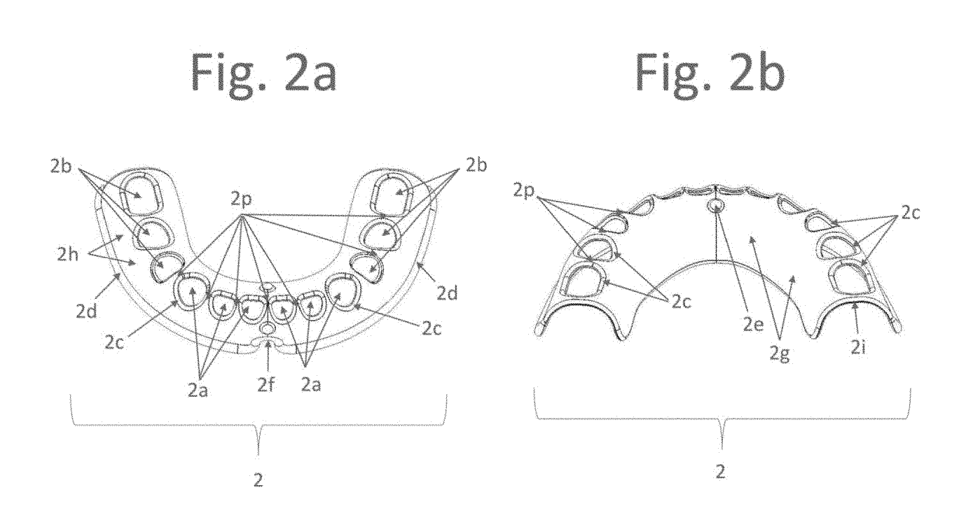

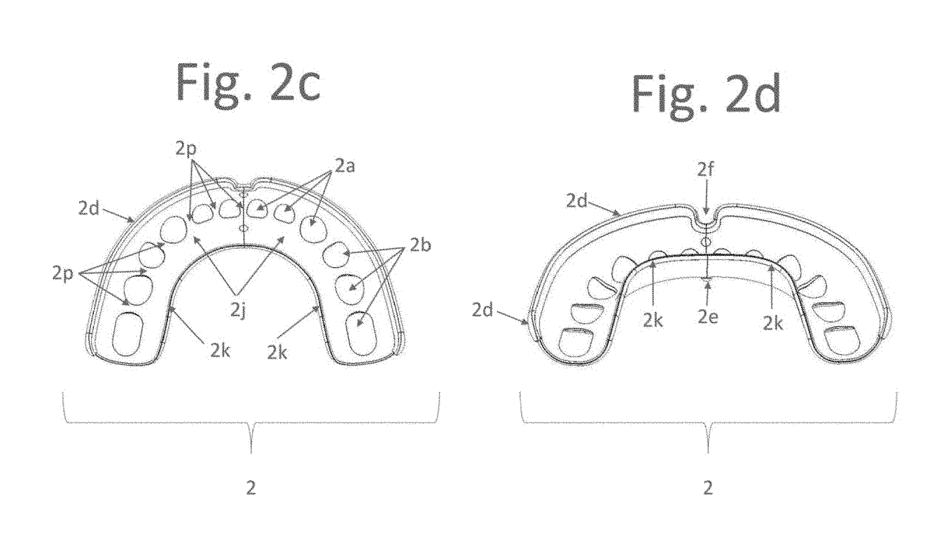

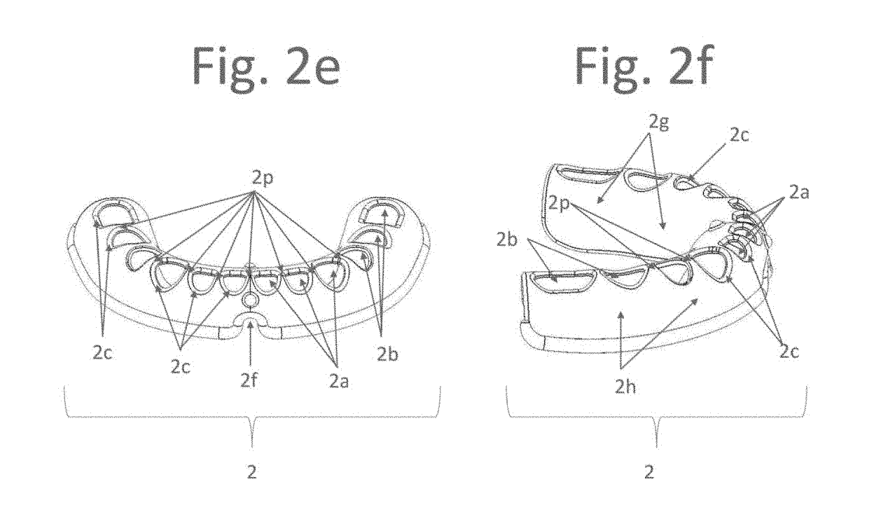

FIG. 2a is a top and front view according to some other embodiments of the self-gripping lower (mandibular) ridge barrier 2; wherein are depicted the anatomically shaped anterior teeth holes 2a, the anatomically shaped posterior teeth holes 2b and the buccal roll border 2d. Further depicted is the buccal ridge aspect Also depicted are the outer aspect of the lower ridge barrier 2 interdental tension bridges 2p which serve the same function as the upper interdental tension bridges for now covering and sealing the lower gum ridge (not depicted).

FIG. 2b is a top and rear view according to some other embodiments of the lower ridge self-gripping barrier 2; wherein are depicted the lingual projection/bump 2e, the lingual ridge aspect 2g, and the occlusal ridge aspect 2i of the lower ridge barrier 2. Also illustrated is the lingual side projection/bump 2e and the thinned out circumferential teeth hole borders 2c as well as the interdental tension bridges 2p.

FIG. 2c is a bottom view according to some other embodiments of the lower ridge self-gripping barrier 2; wherein are depicted the inner aspect 2j, the inner aspects of the interdental tension bridges 2p, the anterior 2a and posterior 2b teeth holes, the buccal roll border 2d, and the lingual roll border 2k for aid in gripping and stretching the ridge barrier 2 and most specifically stretching the interdental tension bridges 2p for the full seating of the ridge barrier 2 past the teeth contacts of the dentulous ridge (not depicted).

FIG. 2d is a bottom and rear view according to some other embodiments of the lower ridge self-gripping barrier 2; wherein are depicted the frenum notch 2f, the lingual side projection/bump 2e and the lingual roll border 2k.

FIG. 2e is a top and front view according to some other embodiments of the lower ridge self-gripping barrier 2; wherein are depicted the interdental tension bridges 2p, the thinned out circumferential borders 2c of the anatomically shaped anterior teeth holes 2a, and posterior teeth holes 2b, and the buccal frenum notch 2f of the lower jaw ridge barrier 2.

FIG. 2f is a top and side view according to some other embodiments of the lower ridge self-gripping barrier 2; wherein are depicted the interdental bridges 2p, the lingual ridge aspects 2g, the buccal ridge aspects 2h and the thinned out circumferential borders 2c of the anatomically shaped anterior teeth holes 2a, and posterior teeth holes 2b of the lower jaw ridge barrier 2.

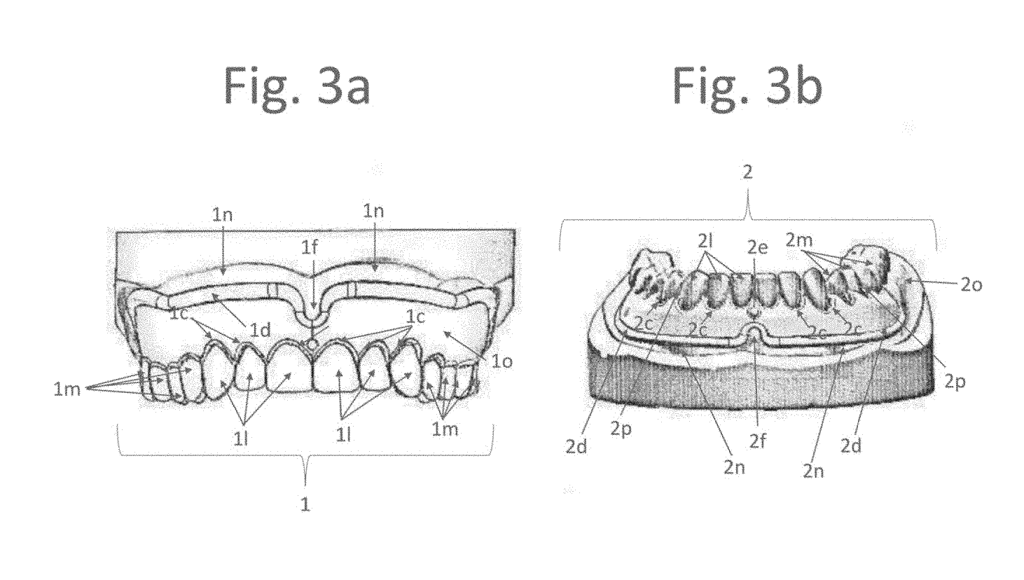

FIG. 3a is a front view of a model of the maxillary jaw wherein are depicted the maxillary ridge 1o covered by the upper self-gripping ridge barrier 1 when said barrier is inserted over and through the erupted portions of the maxillary anterior teeth 1l and maxillary posterior teeth 1m and seated down so that the thinned out circumferential borders 1c of the anatomically shaped anterior teeth holes 1a, and posterior teeth holes 1b are seated at the level of the gumlines respectively of the anterior maxillary teeth 1l and posterior maxillary teeth 1m. Also illustrated is the spatial relation of the buccal roll border 1d to the maxillary muco-buccal fold 1n and the frenum notch's 1f position in relation to the maxillary ridge 1o.

FIG. 3b is a front view of a model of the mandibular jaw wherein are depicted the mandibular ridge 2o covered by the lower self-gripping ridge barrier 2 when said barrier is inserted over and through the erupted portions of the mandibular anterior teeth 2l and mandibular posterior teeth 2m and seated down so that the thinned out circumferential borders 2c of the anatomically shaped anterior teeth holes 2a, and posterior teeth holes 2b are seated at the level of the gumlines respectively of the anterior mandibular teeth 1l and posterior mandibular teeth 1m. Also illustrated is the spatial relation of the buccal roll border 2d to the mandibular muco-buccal fold 2n and the frenum notch's 2f position in relation to the mandibular ridge 2o.

According to some embodiments, a dental oral self-gripping barrier is provided, that is flexible to apply and to remove, that is designed to conform substantially to an anatomic area, and that is both liquid impermeable and gas permeable. In one example, the dental oral barrier is designed to conform to the gum ridge anatomy or a portion of the gum ridge, and has pre-configured or perforated cut-out holes of various shapes and diameters for insertion over and through anatomical crown portions of the teeth (if the teeth are present), and for adaptation around or near to the gum line of the teeth, for example, as described in U.S. Pat. No. 9,539,075, which is fully incorporated within, by the same inventor. Of course, barriers as described herein may be used to cover and/or contain treatment areas besides the oral area, for example, in or on other bodily limbs or parts.

In some embodiments, the device includes a dental oral barrier component for protection against treatment materials (such as a whitening agent) applied to the teeth that may be exposed as well to the surrounding gum tissue of the teeth that are covered (contained) by an oral tooth and/or gum treatment device being used for a treatment cavity or cavities of a mouthpiece, for example, as described in PCT patent application number WO 2013/039906 A1, by the same inventor.

In some embodiments, the dental oral self-gripping barrier includes a treatment material layer on one or more surfaces, wherein the treatment material is suitable for neutralizing treatment materials.

In some embodiments, the device includes a dental oral barrier component which includes a gum treatment layer on its inner surfaces for the delivery of one or more therapeutic treatment materials or medicinal materials to the gums.

In some embodiments the oral self-gripping barrier is formed from a variety of elastomeric materials such as but not limited to: TPE's (thermoplastic elastomers; TPU's (thermoplastic urethanes); elastomeric silicones (RTV, HTV, LSR, HCR) that are substantially both liquid impermeable and gas permeable (i.e., Breathable). For example, they may contain millions of micro-porosities per sq. cm. in their structure that are naturally formed during the mixing and molding process. In some examples, these elastomeric materials preferably would have a tear strength of 40 kN/m or even 50 kN/m or more, and preferably a tensile strength of 8-10 Mpa. Embodiments of these elastomeric materials would preferably have a Shore A hardness of 40 or even preferably 30 or even 20 Shore A hardness. Of course, other ranges may be used.

In some embodiments the oral self-gripping barrier is pre-formed from a variety of High Consistency Rubber Silicone materials (HCR) and is molded using a closed mold transfer injection technique.

This molding process yields a device with minimal or no air bubbles incorporated into the structure of the device which enhances its desired mechanical properties both in terms of ease of insertion, intimate fit, and ease of removal.

If bubbles were present in the barrier, especially in the areas of the interdental bridges, this would seriously impact in a negative manner on the tear strength of these bridges and could lead to tearing of the bridges when attempting to insert them past the teeth contacts.

In some embodiments, the manufacturing process herein described provides for using a stock sized pre-formed (molded) three dimensionally shaped barrier device (e.g., that is non-custom made for a target anatomy) that can be readily and quickly adapted to each patient's specific anatomy to provide a “press fit” to each patient's anatomy. Such a press-fitted barrier may provide a superior substantially elastomeric and flexible barrier that can be used, for example, in the following applications: As a wound dressing cover post oral surgery, periodontal surgery, dental implant surgery and periodontal deep scaling and root planing procedures. Medications such as anti-microbials, antibiotics, tissue regeneratives, anti-inflammatories, analgesics, or other therapeutic agents can be applied under the barrier and maintained in place without appreciable egress of these materials or agents or saliva or other fluid dilution and washout of these materials and agents for an appreciable time of hours or even days or weeks. As a fluid barrier to separate the hard tooth structure from the surrounding moisture contaminated soft tissue of the oral cavity when placing dental resin adhesive fillings or restorations. As a fluid barrier when placing dental bonded resin orthodontic brackets on the teeth.

The barrier as described above may be used as a wound dressing or containment device (with or without impregnating the inner surface with a therapeutic) or as a delivery device itself (e.g., if an additional therapeutic agent is later impregnated on its inner surface as a coating in a later step of the manufacturing process) to hold and maintain a desired volume and concentration of the therapeutic in place onto the target area. As noted above, therapeutic applications include but are not limited to post-periodontal (gum) surgery, post-dental implant surgery, following deep debridement such as scaling and root planing (SRP) as part of a periodic periodontal STM (soft tissue management) regimen for chronic periodontitis patients.

In further embodiments, the initial form of the oral barrier may substantially contain the treatment material in a more effective manner on the target treatment area, and allow for a significantly longer duration, larger quantity and optimal concentration and/or larger surface area application of the treatment material to the applied target area as compared to the known art. This may be advantageous to substantially prevent or limit saliva contamination (filled with pathogenic bacteria) and saliva washout (dilution of the therapeutic in the salivary fluid and its removal as is the case with the prior art).

According to some embodiments, the self-gripping oral barrier device may be placed over the teeth so as to expose the erupted portions of the teeth to the oral cavity (if present) and substantially cover the surrounding gums and or gum ridge after prior application (injecting) of a therapeutic treatment either onto the surface of the gum tissue, onto the tooth surface near the gum line, or into the natural (healthy or diseased) space (sulcus) between the gums and the teeth which often (i.e. prevalence rates of 50-70% in the adult population of industrialized nations) harbor pathogenic bacteria that cause gum disease (gingivitis and periodontitis). This improved exposure of the treatment material to the target treatment area may enable enhanced effectiveness in halting progression of the gum disease or aid in regeneration of healing tissue post-surgery that may reverse the disease state or promote healing of surgically incised tissue to bring the gums back to a state of health.

In further embodiments, if applied to the tooth structure near the gum line that may be partially covered by the self-gripping oral barrier, the treatment material may aid in more effectively re-mineralizing the demineralized (eroded) tooth structure that typically causes temperature (hot and cold) sensitivity to the teeth of patients who have these tooth erosions.

In accordance with further embodiments, a self-gripping barrier device that has been pre-impregnated on its inner surface with a treatment material at the time of fabrication or prior to insertion in the mouth, may have substantially all the advantages of the embodiments described above, while additionally enabling delivery of the therapeutic treatment material effectively and safely to a target location. In some examples this may obviate the need to first apply a treatment material onto or into the tissue to be treated. Such an embodiment may enhance the prevention and/or minimization of saliva contamination (filled with pathogenic bacteria) and saliva washout (dilution of the therapeutic in the salivary fluid and its removal).

As mentioned above, in some embodiments, the elastomeric materials used to form the pre-formed body structure of the oral draping device may be engineered to be differentially permeable (permeable to oxygen to permit “breathing” of the tissue under it and yet impermeable to fluids to prevent saliva contamination and washout). This allows the device to remain inside the oral cavity for extended periods of time.

In still further embodiments as described above, the self-gripping oral barrier device described herein may enable application to a patient anatomy to act as a barrier to prevent moisture contamination of the tooth structure by the surrounding soft tissues, thereby creating what is commonly known in the field of dentistry as a “dry field” (i.e. a substantially moisture-free work area), which is often a very important requirement for properly placing many dental restoratives (fillings etc.) into the teeth. In the currently described embodiment, application of the device may compliment and/or replace the typical rubber dam (typically a flat latex sheet drape), which is relatively cumbersome, time consuming to place (typically requires manually punching holes in it to cover the teeth, placement of a clamping device on one of the teeth to keep the rubber dam in place and often attachment of the rubber dam to an external frame to keep its otherwise loose unsupported sections away from the work area). The currently known rubber dam devices are typically uncomfortable for the patient and challenging for usage by the dentist for the above reasons.

In accordance with some embodiments, the self-gripping oral barrier device may be fabricated in full arch forms to cover all the teeth and surrounding gums of the upper or lower dental arches. It can also be fabricated to cover segments (e.g., anterior or posterior) or fabricated to cover a single tooth or only a few teeth and adjacent surrounding gum tissue.

In accordance with some embodiments, the self-gripping oral drape device may be fabricated with a varying number of perforated or pre-configured cut out teeth holes as well as varying sizes and shapes for said perforated or pre-configured cut out teeth holes.

In additional embodiments, the self-gripping barrier device may be applied outside of the oral cavity, for example, by molding the material to a different shape (such as a sleeve or cuff), for covering a body part (e.g., the knee, elbow, ankle, neck etc.), by providing a “press-fit” geometry and shape to the device that fits snugly to the anatomical part to be covered by the device

In further embodiments the drape device may also be formed in stock sized molded sections (e.g., to cover a limb, a portion of a limb, or a portion of the torso) and so may be used to treat a body area. In one example the drape device may be used to treat skin burn victims by effectively covering and partially immobilizing the damaged body parts substantially (especially in areas where there is normally joint movement of that body part), without the need for applying heavy plaster-type casts. In another example this application may be used where a treatment material may have first been applied separately to the damaged tissue or the treatment material may have been applied to the inner surface of the device prior to placing the device on the body part.

In still further embodiments, as described above, the treatment material to be applied with the self-gripping barrier device may be formulated so that its therapeutic effect is in a time released manner or the treatment material may be first inserted into a manually or electronically controlled pumping device that has first been placed on the treatment area surface and then covered with the therapeutic draping device of the present invention.

The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

What is claimed is:

1. An anatomically pre-shaped oral anatomy barrier for covering a treatment area of an anatomical oral structure, the barrier comprising:
an elastomeric material capable of conforming to the contours of an anatomical oral structure prior and after placement;
wherein the barrier is self-gripping after placement, and
wherein the barrier adapts to the oral structure to provide a substantially fluid sealed cover.

2. The anatomically shaped oral anatomy barrier as claimed in claim 1, wherein the elastomeric material of the drape is flexible both before and after insertion onto the oral structure.

3. The anatomical oral anatomy barrier as claimed in claim 1, wherein the elastomeric material of the drape is substantially liquid impermeable and gas permeable, both before and after insertion onto the oral structure.

4. The anatomically pre-shaped oral anatomy barrier as claimed in claim 1, wherein the barrier conforms to a gum ridge anatomy, wherein the barrier forms an enclosed protective cover over the gum ridge with optional holes for passage of erupted teeth there through.

5. The anatomically pre-shaped oral anatomy barrier as claimed in claim 1, wherein the barrier conforms to press fit onto the gum ridge anatomy.

6. The anatomically pre-shaped oral anatomy barrier as claimed in claim 1, wherein the barrier conforms to a portion of the gum ridge anatomy, wherein the barrier forms an enclosed protective cover over a gum ridge, wherein the barrier includes optional holes for passage of selected erupted teeth there through.

6. The anatomically pre-shaped oral anatomy barrier as claimed in claim 1, wherein the barrier conforms to the gum ridge anatomy, and wherein the barrier forms an enclosed protective cover over a gum ridge, wherein the barrier includes holes for passage of erupted selected teeth there through, wherein the barrier is designed to provide substantially full coverage over portions of the gum ridge that are edentulous.

7. The anatomically pre-shaped oral anatomy barrier as claimed in claim 1, wherein the cross-sectional thickness of the barrier is thinner around the teeth holes.

8. The anatomically pre-shaped oral anatomy barrier as claimed in claim 7, wherein the borders of the teeth holes slope inward to provide a thinner cross-sectional shape on the outer aspects of the barrier.

9. The anatomical barrier as claimed in claim 1, further comprising a thickened peripheral roll border to aid in the placement and/or insertion of the barrier.

10. The anatomical barrier as claimed in claim 1, further comprising alignment bumps to aid in orienting and/or inserting of the barrier over and through teeth that are present.

11. The oral anatomy barrier of claim 1, where the barrier is designed to conform to a gum ridge and is designed for an elastomeric mouthpiece that substantially covers the teeth and gum ridge(s) to conform onto the barrier, to provide for a substantial continuous fluid seal of between the mouthpiece's internal treatment cavities and the barrier(s).

12. The anatomical barrier as claimed in claim 1, further comprising one or more treatment material layers on at least one surface of the barrier.

13. A kit of parts for covering a treatment area in an anatomical oral structure, the kit comprising a plurality of anatomical barriers, each barrier including elastomeric material capable of conforming to the contours of the anatomical oral structure prior to and after placement;
wherein the barrier is self-gripping after placement, and
wherein the barrier adapts to the oral structure to provide a substantially fluid sealed cover.

14. The kit of claim 13, further comprising one or more therapeutic materials.

15. The kit of claim 13, further comprising one or more treatment materials.

16. A method for applying an oral self-gripping ridge barrier to cover a treatment area of an oral cavity, the method comprising:
a barrier that is of smaller dimension than the barrier it cover and so provides a press fitting barrier so that it substantially conforms to the contours of the oral anatomical part to be treated, wherein the press fit provides a substantially fluid sealed covering of the oral anatomical part, and wherein the fully seated barrier remains elastomeric and is substantially gas permeable but liquid impermeable.
